(19) United States
(12) Patent Application Publication
(10) Pub. No.: US 2004/0192546 A1
(43) Pub. Date: Sep. 30, 2004

(54) Catalyst for the low temperature oxidation of methane

(76) Inventors: Zhongyuan Dang, Canton, MA (US); Yinyan Huang, Framingham, MA (US); Amiram Bar-llan, Brookline, MA (US)

Correspondence Address: Sud-Chemie Inc., 1600 West Hill Street, Louisville, KY, 40210, US

(21) Appl. No.: 10/400,763

(22) Filed: Mar. 27, 2003

(51) Int. Cl. B01J 23/56

(52) U.S. Cl. 502/325; 502/332

(57) ABSTRACT

The present development is a catalyst for the low temperature catalytic oxidation of methane in the presence of hydrogen and water. The catalyst comprises a high surface area alumina, tin oxide and at least one noble metal selected from the group consisting of palladium, platinum, rhodium or a combination thereof, washcoated on a monolithic support. The resultant catalyst is more durable than prior art catalysts.

### BACKGROUND

The present development is a catalyst for the low temperature catalytic oxidation of methane in the presence of hydrogen and water. The catalyst comprises a high surface area alumina, tin oxide and at least one noble metal selected from the group consisting of palladium, platinum, rhodium or a combination thereof, washcoated on a monolithic support. The resultant catalyst is more durable than prior art catalysts.

Natural gas (methane) is playing a more and more important role as a potential energy source. For example, natural gas is widely used as the fuel source for gas turbine engines. In comparison to conventional fossil fuels, such as gasoline and diesel fuel, methane has a higher energy density and it burns cleaner. Further, a natural gas fueled engine produces substantially less NOx and particulate than a similarly sized diesel engine.

However, methane is a greenhouse gas and so it is desirable to control its emission. Modern gas turbine engines are designed to promote the catalytic combustion of methane at relatively low temperatures. These reactions result in low methane emissions and in relatively low levels of NOx emissions. The catalytic combustion of methane can be carried out under either fuel-lean conditions or fuel-rich conditions. Fuel-lean combustion of methane is desired for high efficiency and simple system design, but tends to result in faster deactivation of a conventional noble metal catalyst. Fuel-rich combustion promotes stability of the catalyst, but the overall efficiency of combustion is lower.

Methane is also a typical fuel for fuel cell applications. In various types of fuel cells, after reforming and other purification, the fuel mixture entering stack is a mixture of H₂, unconverted methane and water. The flue gas from stack typically contains unconverted H₂, methane and water. Catalytic combustion is used to remove H₂ and methane before being released to atmosphere. A long life of the fuel cell is always desired and the requirement for long durability of catalyst is also high.

The catalysts for the low temperature catalytic oxidation of methane are known in the art. These catalysts typically comprise a palladium-containing complex supported on a high surface area alumina. Alternatively, platinum and/or rhodium can be added to the catalyst compositions in addition to or in place of palladium. The resultant noble metal catalysts have been shown to offer acceptable activity, lightoff temperature and resistance to volatilization. But, durability is also an important parameter for reliable operation of a catalyst, and the noble metal/alumina catalysts generally require additional metals, such as cerium, lanthanum and other rare earth elements, to stabilize the surface of the alumina and noble metal structure. These elements can significantly add to the cost of the catalyst.

### SUMMARY OF THE PRESENT INVENTION

The present development is modification of a traditional noble metal/alumina catalyst. The catalyst comprises tin oxide in the alumina washcoat of a noble metal catalyst, wherein the noble metal is selected from the group consisting of palladium, platinum, rhodium and combinations thereof. In the presence of hydrogen and water, the catalyst has a low lightoff temperature for methane and it is stable under fuel-lean conditions.

### BRIEF DESCRIPTION OF THE FIGURES

FIG. 1 is a graphical representation of methane conversion versus temperature for a catalyst prepared with a prior art alumina carrier and for a catalyst prepared with a tin oxide containing alumina carrier; and

FIG. 2 is a graphical representation of methane conversion versus time on stream for a catalyst prepared with a prior art alumina carrier and for a catalyst prepared with a tin oxide containing alumina carrier.

### DETAILED DESCRIPTION OF THE PRESENT INVENTION

The present development is a catalyst for the low temperature catalytic oxidation of methane in the presence of hydrogen and water. The catalyst comprises a high surface area alumina, tin oxide and at least one noble metal selected from the group consisting of palladium, platinum, rhodium and combinations thereof supported on a monolith support. The catalyst is prepared by washcoating a mixture of tin oxide and alumina on a monolith support followed by impregnation with a noble metal.

The monolith support can be any form of a monolith as is known in the art. For the present development, the support of the catalyst is preferably selected from ceramic or metallic honeycombs, because a honeycomb type support has a large geometric surface area and will create less pressure drop than a particulate catalyst support. The advantage of the honeycomb is seen at a high space velocity such as found in the emission control of a natural gas engine or gas turbine where less pressure drop is desired for high energy efficiency.

The alumina of the catalyst of the present development preferably has a surface area of from about 50 to about 400 m²/g. Although surface area is not a critical variable, the higher the surface area, the better the dispersion of tin oxide and noble metal within the catalyst and the better the performance of the resultant catalyst. Preferably, the alumina of the catalyst is a γ-alumina or modified alumina, although other aluminas, such as β-alumina and α-alumina may also be used. Further, other carrier materials, such as alumino-silicates may be substituted for the alumina.

For the present application, pure γ-alumina does not have sufficient thermal stability to protect against adverse temperatures. Instead, a modified alumina is typically used for the catalyst preparation. Depending upon the different doping methods and procedures, the resultant alumina will have high surface area and high thermal stability and surface modification effect for high precious metal dispersion. For catalyst preparation, the general practice is to add La, Ce, Y, and other real earth elements for modification. Other elements such as Si, Zr, and Ti are also used as alumina modifications. A specially available La-doped alumina is used in the present development. The material has a high surface area and high thermal stability. Its surface area retains above 100 m²/g after 100° C. calcination. In comparison, unmodified alumina has surface area of only about 10 m²/g to about 20 m²/g.

The tin oxide of the catalyst is a known compound available as a powder or granule from Magnesium Electron Inc. or Keeling and Welker LTD and sold commercially under the product code Meta Stannic acid (Acid tin oxide) or Tin (Stannic oxide). For use in the catalyst, the tin oxide is preferably supplied as a fine mesh powder. The tin oxide is added to the catalyst at a concentration of from about 10 wt % to about 50 wt %.

The noble metals of the catalyst are selected from the group consisting of palladium, platinum, rhodium and combinations thereof. Preferably, the metal is added to the catalyst as soluble compounds, such as platinum sulfite acid, palladium nitrate and rhodium nitrate. Specifically, platinum sulfite acid which was developed and patented by the assignee leads to higher dispersion of Pt in final catalyst than other platinum compounds such platinum tetra-ammonia nitrate. The noble metals added to the catalyst to deliver a total noble metal concentration of from about 0.1 wt % to about 5 wt %. If more than one metal is used, the relative concentrations may be varied.

In an example of a catalyst made in accordance with the present invention, a catalyst is prepared by washcoating a mixture of tin oxide and alumina onto a monolithic support. The washcoating slurry is prepared by mixing tin oxide, La-doped alumina and alumina colloid followed by processing in a ball mill for about 4 hours. The relative weight ratio of tin oxide to alumina could vary from 1% to 99%. A ceramic honeycomb of size 1.75″ diameter by 2″ length and 400 cpsi is dipped into the slurry. Extra slurry is removed by air-knifing and the resultant monolith is dried and cured at 550° C. for 3 hours. The final washcoating loading is 2 g/in³. The washcoated monolith is dipped into the solution of platinum sulfite acid solution followed by extra liquid removal, drying and calcination at 550° C. for three hours. Pd is loaded as a last step with the use of palladium nitrate solution in the same way.

One exemplary catalyst prepared using the technique of the previous paragraph has a Pd/Pt loading of about 100 g/ft³ and a Pd/Pt ratio of about 2:1. The Pd/Pt loading and Pd/Pt ratio can vary in a wide range. The resultant catalyst was tested under conditions of about 3% hydrogen gas, about 2500 ppm methane, about 5% water, about 73% nitrogen and about 19% oxygen and with a space velocity of about 50,000/h GHSV. The resultant catalyst surprisingly demonstrates an enhanced activity and improved stability relative to prior art Pd/Pt/alumina catalysts under lean-fuel reaction conditions.

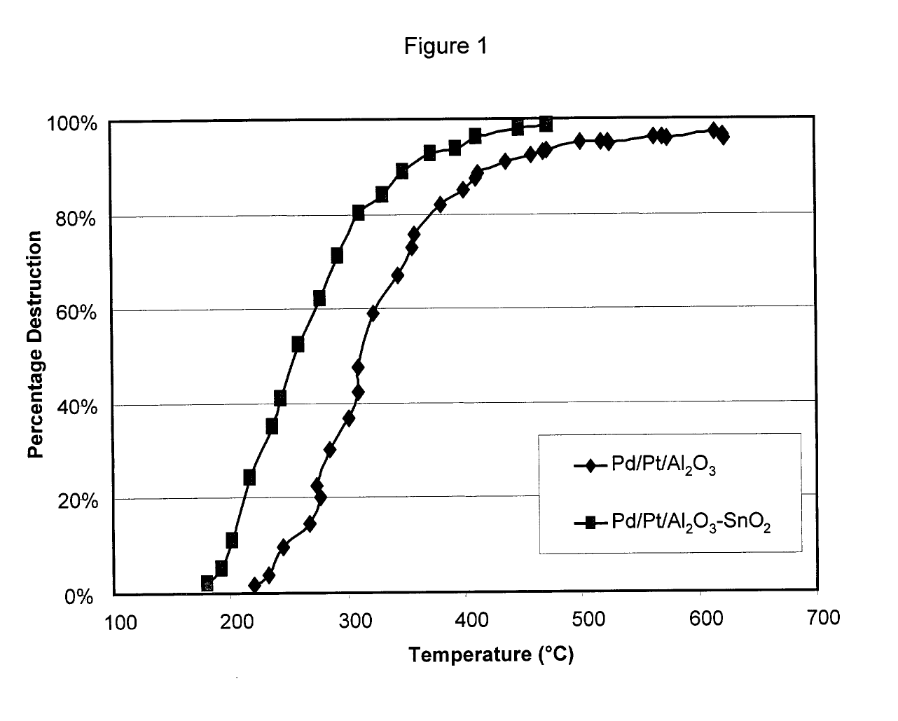

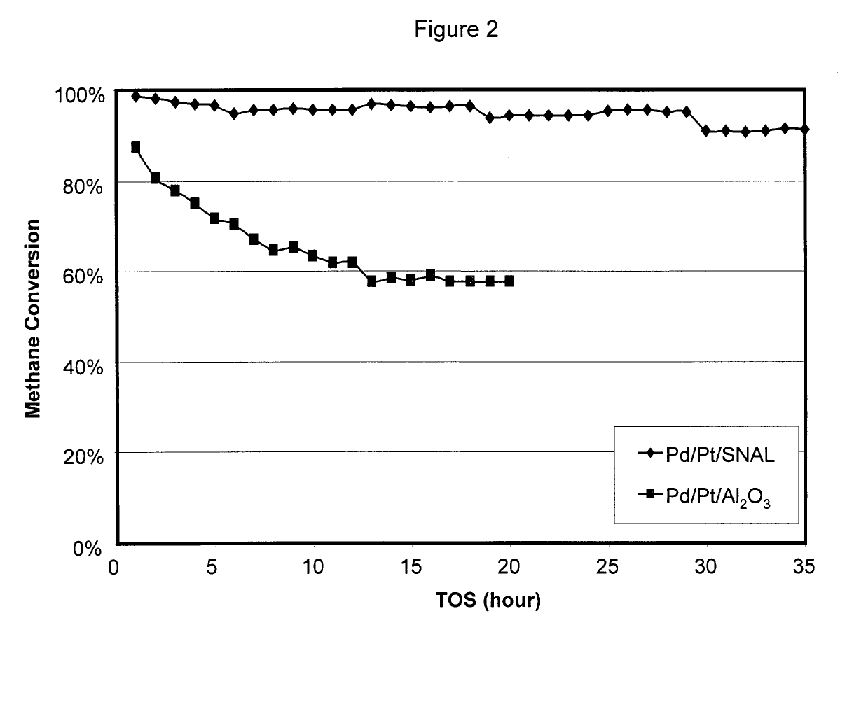

As shown in FIG. 1, the catalyst demonstrates a lightoff temperature (50% methane conversion) of about 250° C. Further, as shown in FIG. 2, the catalyst is stable at about 500° C. for an extended period of time on-stream.

For comparative purposes, a prior art catalyst was prepared and tested under essentially the same conditions. A conventional alumina washcoating slurry is prepared by processing in the ballmill the mixture of La doped alumina and alumina colloid. A ceramic honeycomb of about 1.75″ diameter by about 2″ length and 400 cpsi is dip-coated with the slurry, dried and cured at 550° C. for about three hours. The final alumina washcoating loading is 2 g/cf . The washcoated monolith is further catalyzed with Pd and Pt and the final Pd/Pt loading is 100 g/cf (Pd/Pt=2/1). Under essentially the same testing conditions, the conventional Pd/Pt/Al₂O₃ catalyst has a lightoff temperature of about 390° C. Further, the catalyst initially has a relatively high level of methane conversion, but the catalyst deactivates quickly losing over 30% of its activity within a few hours.

From a reading of the above, one with ordinary skill in the art should be able to devise variations to the inventive features. For example, the catalyst monolith may be varied provided it is an essentially inert support. These and other variations are believed to fall within the spirit and scope of the attached claims.

What is claimed is:

1. A catalyst for the low temperature catalytic oxidation of methane in the presence of hydrogen and water, said catalyst comprising:
a. a monolith support;
b. a high surface area alumina;
c. a tin oxide; and
d. at least one noble metal selected from the group consisting of palladium, platinum, rhodium and combinations thereof:

2. The catalyst of claim 1 wherein the alumina has a surface area of from about 50 to about 400 m²/g.

3. The catalyst of claim 2 wherein the alumina is selected from the group consisting of γ-alumina, modified alumina and combinations thereof.

4. The catalyst of claim 1 wherein the tin oxide is a fine mesh powder.

5. The catalyst of claim 4 wherein the tin oxide is added to the catalyst at a concentration of from about 1 wt % to about 99 wt %.

6. The catalyst of claim 1 wherein the noble metal is selected from the group consisting of palladium, platinum, rhodium and combinations thereof.

7. The catalyst of claim 6 wherein the noble metal is added to the catalyst as a soluble compound.

8. The catalyst of claim 1 wherein the noble metals added to the catalyst to deliver a total noble metal concentration of from about 0.1 wt % to about 5 wt %.

9. The catalyst of claim 1 wherein the support is selected from a ceramic honeycomb, a metallic honeycomb and a combination thereof.

10. A catalyst for the low temperature catalytic oxidation of methane in the presence of hydrogen and water, said catalyst prepared by washcoating a mixture of tin oxide and alumina onto a monolithic support, and impregnating said tin oxide/alumina washcoated support with at least one noble metal selected from the group consisting of palladium, platinum, rhodium and combinations thereof.

11. The catalyst of claim 10 wherein the alumina has a surface area of from about 50 to about 400 m²/g.

12. The catalyst of claim 10 wherein the tin oxide is added to the catalyst at a concentration of from about 1 wt % to about 99 wt %.

13. The catalyst of claim 10 wherein the noble metal is selected from the group consisting of palladium, platinum, rhodium and combinations thereof.

14. The catalyst of claim 10 wherein the noble metals added to the catalyst to deliver a total noble metal concentration of from about 0.1 wt % to about 5 wt %.

15. A catalyst for the low temperature catalytic oxidation of methane in the presence of hydrogen and water, said catalyst comprising:
a. a monolith support;
b. from about 1 wt % to about 99 wt % high surface area alumina;
c. from about 1 wt % to about 99 wt % tin oxide; and
d. at least one noble metal selected from the group consisting of palladium, platinum, rhodium and combinations thereof.

16. The catalyst of claim 15 wherein the noble metals added to the catalyst to deliver a total noble metal concentration of from about 1 wt % to about 5 wt %.

17. The catalyst of claim 15 wherein the support is selected from a ceramic honeycomb, a metallic honeycomb and a combination thereof.

18. The catalyst of claim 15 prepared by washcoating a mixture of said tin oxide and said alumina onto said monolithic support, and impregnating said tin oxide/alumina washcoated support with at least one said noble metal.
